(19) United States
(12) Patent Application Publication
(10) Pub. No.: US 2024/0198334 A1
(43) Pub. Date: Jun. 20, 2024

(54) MAGNETIC SEPARATION DEVICE

(71) Applicant: Industrial Technology Research Institute, Hsinchu (TW)

(72) Inventors: NIEN-JEN CHOU, Hsinchu City (TW); WEN-TING CHIANG, Hsinchu County (TW); TING-HSUAN CHEN, Hsinchu County (TW); SU-FENG CHIOU, Miaoli County (TW); LI-AN WU, New Taipei City (TW)

(21) Appl. No.: 18/082,818

(22) Filed: Dec. 16, 2022

(51) Int. Cl. B01L 3/00

(52) U.S. Cl. CPC B01L 3/502761; B01L 2200/0647; B01L 2300/0832; B01L 2300/0877; B01L 2400/043

(57) ABSTRACT

A magnetic separation device includes a sleeve and two fixing portions. The sleeve includes a sleeve body and a hollow portion. The hollow portion penetrates through the sleeve body. The two fixing portions are individually disposed oppositely to a first end and a second end of the sleeve body. Each of the two fixing portions includes a protruding body and a groove. The protruding body is protruded out from an outer surface of the sleeve body, and the groove is disposed at an outer surface of the protruding body.

### TECHNICAL FIELD

The present disclosure relates in general to a magnetic separation device.

### BACKGROUND

While in conducting experiments of separating magnetic substances, the magnetic substances shall be able to be quickly and massively separated from biological samples, without having safety impacts on biological samples. Those impacts include a risk of affecting the survival of biological samples and possible mutual interference and contamination while in separating a large amount of different biological samples. In those situations, efficiency, convenience, automation, bio-safety and biocompatibility must be considered. In general, those work with satisfied separation efficiency usually meets problems in inconvenient use or failing to pass terms of bio-safety and biocompatibility. On the other hand, those work with convenient use usually meets problems in poor separation efficiency. Obviously, perfect work is hard to achieved. Therefore, an issue how to provide a magnetic separation device to improve the above-mentioned problems is definitely urgent to be solved for the skill in the art.

### SUMMARY

An object of the present disclosure is to provide a magnetic separation device that is selectable to determine a specific surface material or treatment to pair different biological samples.

In one embodiment of this disclosure, a magnetic separation device includes a sleeve and two fixing portions. The sleeve includes a sleeve body and a hollow portion. The hollow portion penetrates through the sleeve body. The two fixing portions are individually disposed oppositely to a first end and a second end of the sleeve body. Each of the two fixing portions includes a protruding body and a groove. The protruding body is protruded out from an outer surface of the sleeve body, and the groove is disposed at an outer surface of the protruding body.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of an embodiment of the magnetic separation device in accordance with this disclosure;

FIG. 2 is a schematic top view of FIG. 1;

FIG. 3 is a schematic view of another embodiment of the magnetic separation device in accordance with this disclosure;

FIG. 4 is a schematic perspective view of the fixing portion of FIG. 3;

FIG. 5 demonstrates schematically a pair of a separation tube and the magnetic separation device of FIG. 3;

FIG. 6 is a schematic view of a further embodiment of the magnetic separation device in accordance with this disclosure;

FIG. 7A is a schematic perspective view of the fixing portion of FIG. 6;

FIG. 7B is another view of FIG. 7A;

FIG. 8A is a schematic perspective view of a fixing portion of one more embodiment of the magnetic separation device in accordance with this disclosure;

FIG. 8B is another view of FIG. 8A; and

FIG. 9 is a schematic view of one further more embodiment of the magnetic separation device in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the following description of this disclosure, terms such as “including”, “comprising” and “having” are all open terms, which means “including but not limited to”.

In the description of various embodiments, when terms such as “first”, “second” and the like are used to describe elements, they are only used to distinguish these elements from each other, and do not limit the order or importance of these elements.

In the description of various embodiments, the so-called “coupling” or “connecting” may refer to two or more elements being in direct physical or electrical contact with each other, or indirect physical or electrical contact with each other, and the “coupling” or the “connecting” can also refer to two or more elements inter-operating or acting.

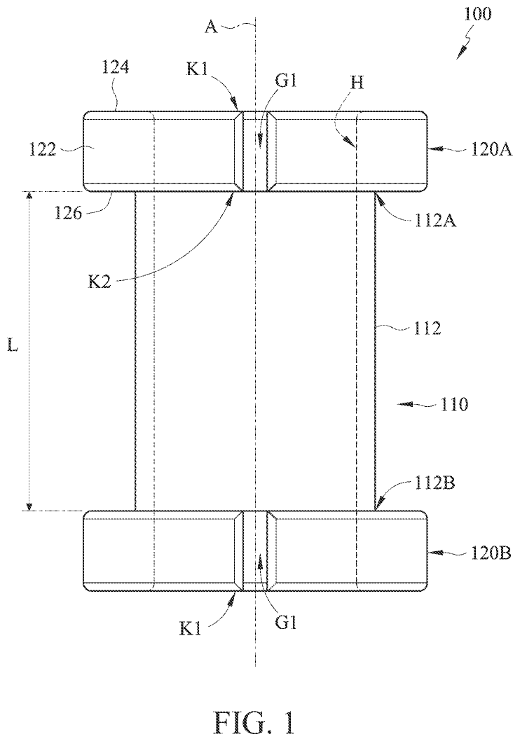

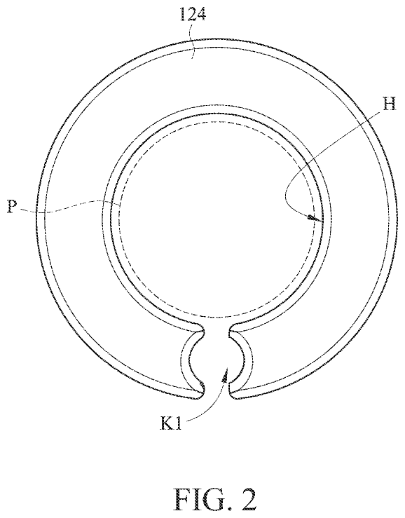

FIG. 1 is a schematic view of an embodiment of the magnetic separation device in accordance with this disclosure, and FIG. 2 is a schematic top view of FIG. 1. As shown, the magnetic separation device 100 can be formed as a unique piece, and includes a sleeve 110 and two fixing portions 120A, 120B. The sleeve 110 includes a sleeve body 112 and a hollow portion H, in which the hollow portion H is formed to penetrate through the sleeve body 112. Preferably, the hollow portion H is a straight through hole; i.e., the sleeve body 112 has an internal through hole portion H, and the sleeve body 112 can be a cylinder. In another exemplary example, the hollow portion H can be a round through hole or a blind hole, and an outer surface z of the sleeve body 112 can be a smooth structure. The sleeve body 112 is made of a material that allows magnetic lines to pass through, such as a silicon or a plastics. In this embodiment, the hollow portion H can fit with a magnetic part P. In this embodiment, a size of the hollow portion H can be adjusted according to that of the magnetic part P, so that the inner wall of the sleeve body 112 can tightly contact the outer wall of the magnetic part P. In addition, the magnetic part P can be replaceable and determined according to different bio-samples for the corresponding separation treatments.

In this embodiment, the two fixing portions 120A, 120B are oppositely disposed at a first end 112A and a second end 112B of the sleeve body 112, respectively. The two fixing portions 120, 120B are identically structured, and separated by a distance L, equal to the length of the sleeve body 112, but being adjustable per practical requirements and not limited thereto. Each of the two fixing portions 120A, 120B includes a protruding body 122 and a groove G1. The protruding body 122 is protruded from an outer surface of the corresponding first end 112A or second end 112B of the sleeve body 112. The protruding body 122 can be a cylinder having a diameter greater than another diameter of the sleeve body 112. In some other embodiments, the protruding body 122 can be some other relevant parts or protrusions. In this embodiment, each of the two protruding bodies 122 has oppositely an outer wall surface 124 and an inner wall surface 126. The two inner wall surfaces 126 are individually disposed right close to the corresponding first end 112A and second end 112B of the sleeve body 112, respectively.

In this embodiment, the groove G1 is structured openly at the protruding body 122. In one exemplary example, the groove G1 is formed as a notch groove at the protruding body 122 extending from the outer wall surface 124 thereof to the inner wall surface 126 thereof. The groove G1 is furnished with a first hole portion K1 to the outer wall surface 124 of the protruding body 122. As shown in FIG. 2, the first hole portion K1 is formed as a round hole. On the other hand, the groove G1 is furnished with a second hole portion K2 to the inner wall surface 126 of the protruding body 122, and the second hole portion K2 can be shaped by resembling the first hole portion K1. In addition, the groove G1 is formed between the first hole portion K1 and the second hole portion K2, and size and shape of the groove G1 can be adjusted according to practical requirements.

In this embodiment, the groove G1 is extended from the first hole portion K1 to the second hole portion K2 in a manner of being parallel to an axial direction A of the sleeve body 112. Namely, the connection line extending from the first hole portion K1 at the outer wall surface 124 of the protruding body 122 to the second hole portion K2 at the inner wall surface 126 of the same protruding body 122 is parallel to the axial direction A of the sleeve body 112.

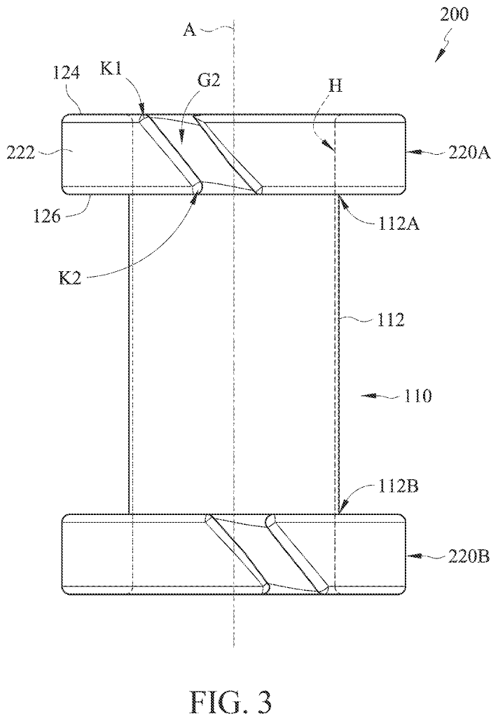

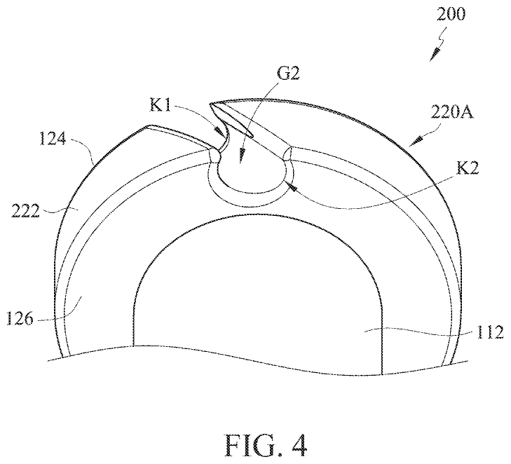

However, embodiments according to this disclosure are not limited to the aforesaid embodiment. Refer to FIG. 3 and FIG. 4; where FIG. 3 is a schematic view of another embodiment of the magnetic separation device in accordance with this disclosure, and FIG. 4 is a schematic perspective view of the fixing portion of FIG. 3. The magnetic separation device 200 of FIG. 3 is functionally and structurally similar to the magnetic separation device 100 of FIG. 1, but a difference in between is at the groove G2 of the fixing portion 220A or 220B. The groove G2 is formed on the surface of the protruding body 222 by extending in an extending direction from the first hole portion K1 to the second hole portion K2. The extending direction of the groove G2 is not parallel to the axial direction A of the sleeve body 112. Namely, the connection line extending from the first hole portion K1 at the outer wall surface 124 of the protruding body 222 to the second hole portion K2 at the inner wall surface 126 of the same protruding body 222 is not parallel to the axial direction A of the sleeve body 112, but an inclined angle is present. Such an inclined angle can be determined according to practical situations.

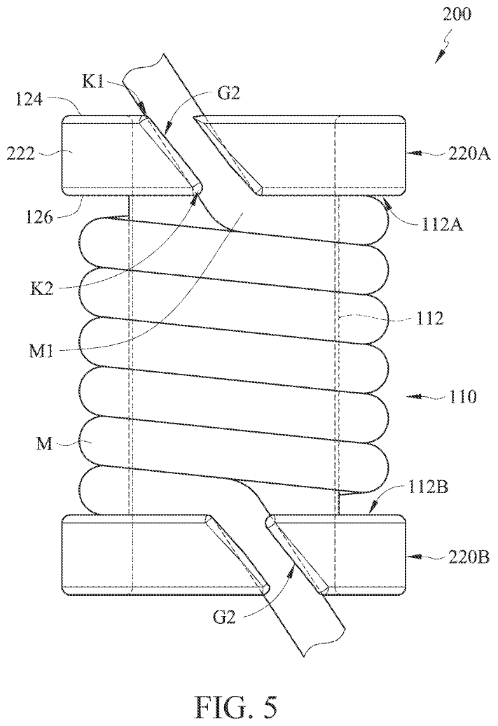

Upon such an arrangement, as shown in FIG. 5, the separation tube M1 of this disclosure adopts a certificate bio-compatible tube having an outer surface with a relevant surface furnish to meet different bio specimens for undergoing specific separation treatments. The separation tube M1 can wind around the sleeve body 112, by entering from the groove G2 of the fixing portion 220A and leaving via the groove G2 of the fixing portion 220B. Namely, the two fixing portions 220A, 220B are utilized to fix the leading and tailing ends of the separation tube. In addition, since the sleeve body 112 provides a smooth surface, thus the separation tube M1 can directly contact the sleeve 110 with a larger contact area. Also, by providing the magnetic part P (as shown in FIG. 2) inside the sleeve 110, the effect of magnetic lines can be further enhanced. When a bio specimen containing magnetic substances to be separated enters the magnetic separation device 200 of this disclosure, the magnetic substances can be separated in a stable and efficient manner without possible foreign poison or hurt upon the specimen. In addition, since the groove G2 of this disclosure can be obliquely extended and leave the sleeve body 112 via the first end 112A and the second end 112B, thus the separation tube M1 can wind around the sleeve body 112 in the extending direction of the groove G2, such that the possibility in twisting the separation tube M1 at the two fixing portions 220A, 220B can be substantially reduced, and so the circulation probability of the bio specimens can be significantly improved.

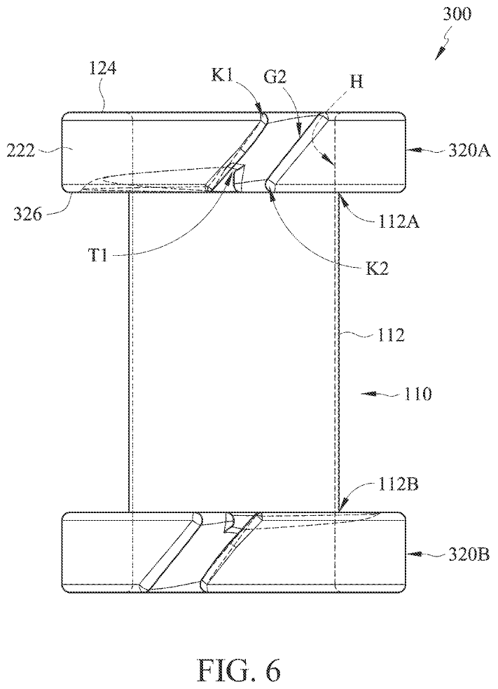

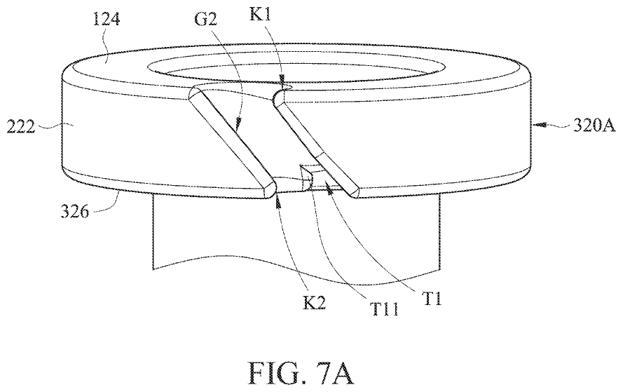

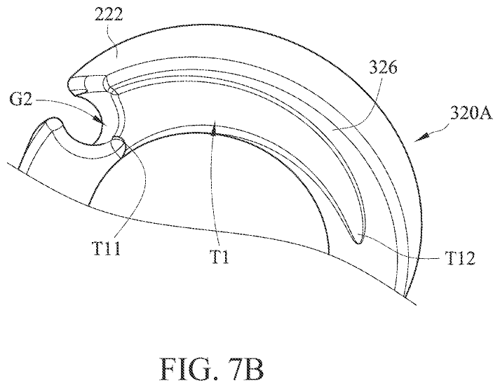

FIG. 6 is a schematic view of a further embodiment of the magnetic separation device in accordance with this disclosure, FIG. 7A is a schematic perspective view of the fixing portion of FIG. 6, and FIG. 7B is another view of FIG. 7A. The magnetic separation device 300 of FIG. 6 is functionally and structurally similar to the magnetic separation device 200 of FIG. 3, but a difference in between is that, in this embodiment, each of the fixing portions 320A, 320B contains an extension groove T1 concavely disposed at a wall of the protruding body 222 (for example, the inner wall surface 326 of FIG. 6). The extension groove T1, structured on the inner wall surface 326, includes oppositely a first end T11 and a second end T12. The first end T11 of the extension groove T1 is connected spatially with the groove G2, and a width of the extension groove T1 is tapered from the first end T11 to the second end T12 so as to form a gradient groove. Thereupon, the extension groove T1 can be used to enlarge a space for extending the separation tube (not shown in the figure), such that possible squeezing of the separation tube at the fixing portions 320A, 320B can be avoided.

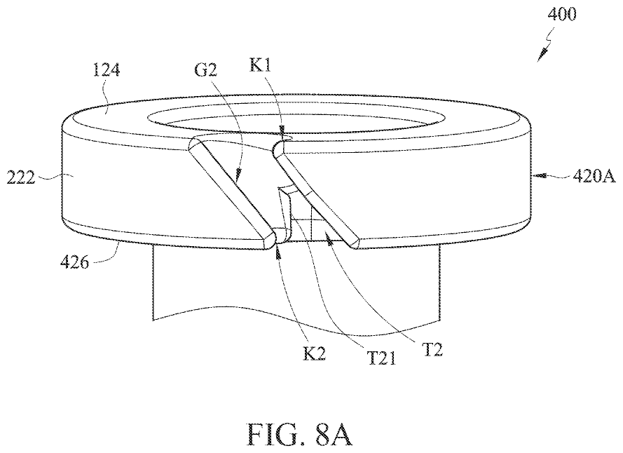

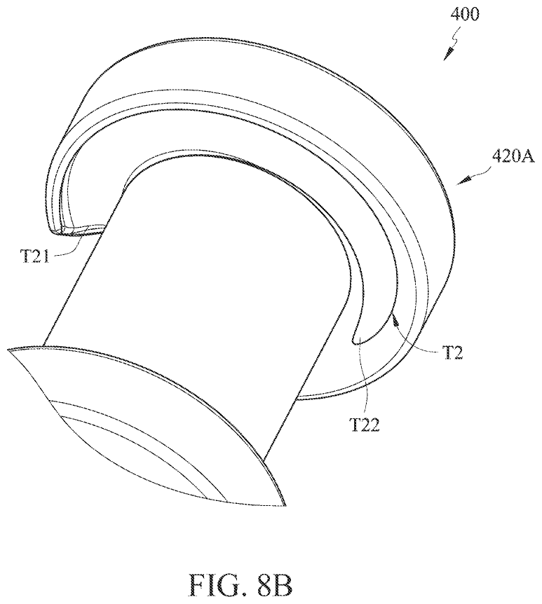

It shall be explained that the depth of the first end T11 (see FIG. 7A) of the aforesaid extension groove T1 (i.e., the depth of the groove on the inner wall surface 326) can be adjusted according to practical situations. As shown, the magnetic separation device 400 of FIG. 8A or FIG. 8B is functionally and structurally similar to the magnetic separation device 300 of FIG. 6. Similarly, the inner wall surface 426 is furnished with an extension groove T2. A first end T21 of the extension groove T2 is connected spatially with the groove G2, and a width of the extension groove T2 is tapered from the first end T21 to the second end T22 so as to form a gradient groove. Thereupon, an obvious change at this embodiment is that a depth of the extension groove T2 of the fixing portion 420A at the first end T21 is greater than another depth of the extension groove T1 at the first end T11 of FIG. 6.

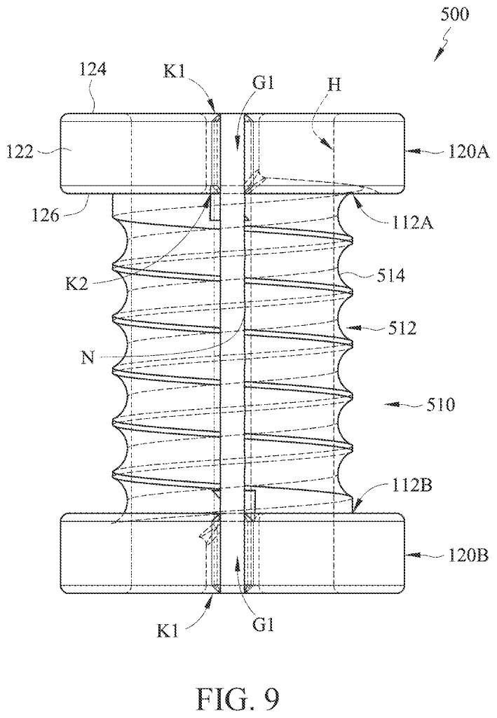

FIG. 9 is a schematic view of one further more embodiment of the magnetic separation device in accordance with this disclosure. As shown, the magnetic separation device 500 in this embodiment is functionally and structurally similar to the magnetic separation device 100 of FIG. 1, with the major difference at the sleeve 510. In this embodiment, an outer surface of the sleeve body 512 of the sleeve 510 is a non-smooth structure, such as a coarse surface. In another embodiment not shown herein, the outer surface of the sleeve body 512 can be a spiral groove 514. In addition, the sleeve 510 includes a through groove N disposed on the outer surface of the sleeve body 512 and connected spatially with the hollow portion H. Namely, in this embodiment, the sleeve 510 is formed as a C shape, such that the sleeve 510 can contact tightly the magnetic part inside the hollow portion H.

In summary, the magnetic separation device provided in this disclosure can be applied to process the separation of the magnetic substances. The magnetic separation device can be relevantly modified to process different bio-samples, such that the efficiency in separating the magnetic substances can be enhanced, and the effect from the bio-samples can be reduced.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A magnetic separation device, comprising:
a sleeve, including a sleeve body and a hollow portion, the hollow portion penetrating through the sleeve body; and
two fixing portions, individually disposed oppositely to a first end and a second end of the sleeve body, each of the two fixing portions including a protruding body and a groove, the protruding body being protruded out from an outer surface of the sleeve body, the groove being disposed at an outer surface of the protruding body.

2. The magnetic separation device of claim 1, wherein the outer surface of the sleeve body is a smooth structure.

3. The magnetic separation device of claim 1, wherein the outer surface of the sleeve body is a non-smooth structure.

4. The magnetic separation device of claim 1, wherein the outer surface of the sleeve body is a spiral groove.

5. The magnetic separation device of claim 1, wherein an extending direction of the groove is parallel to an axial direction of the sleeve body.

6. The magnetic separation device of claim 1, wherein an extending direction of the groove is not parallel to an axial direction of the sleeve body.

7. The magnetic separation device of claim 1, wherein each of the two fixing portions includes an extension groove concavely disposed at an inner wall of the protruding body.

8. The magnetic separation device of claim 7, wherein one end of the extension groove is connected spatially with the groove.

9. The magnetic separation device of claim 1, wherein the sleeve includes a through groove disposed at the outer surface of the sleeve body and connected spatially with the hollow portion.
